(19) United States
(12) Patent Application Publication
(10) Pub. No.: US 2026/0138159 A1
(43) Pub. Date: May 21, 2026

(54) Pickleball Paddle Cleaner Apparatus

(71) Applicant: Ofinno, LLC, Reston, VA (US)

(72) Inventors: Aaron GORE, Fairfax, VA (US); Esmael Hejazi DINAN, McLean, VA (US)

(21) Appl. No.: 19/221,481

(22) Filed: May 28, 2025

Related U.S. Application Data
(60) Provisional application No. 63/654,156, filed on May 31, 2024.

(51) Int. Cl. B08B 1/14; A63B 60/00; A63B 102/08; B08B 1/12; B08B 1/30; B08B 1/40; B08B 13/00; G01L 5/00

(52) U.S. Cl. CPC B08B 1/14; A63B 60/00; B08B 1/12; B08B 1/30; B08B 1/40; B08B 13/00; G01L 5/0038; A63B 2102/08

(57) ABSTRACT

An example pickleball paddle cleaning apparatus includes a first cleaning pad arranged on a first plate, a second cleaning pad arranged on a second plate, and a pressure-exertion mechanism configured to move at least one of the first plate and the second plate so that the first cleaning pad and the second cleaning pad simultaneously contact a front striking surface and a back striking surface, respectively, of a pickleball paddle that is temporarily inserted between the first cleaning pad and the second cleaning pad.

### CROSS REFERENCE TO RELATED APPLICATIONS

This application claims priority from U.S. Provisional Application No. 63/654,156 filed May 31, 2024, the entire content of which is herein incorporated by reference.

### FIELD

This disclosure relates to pickleball paddle cleaning apparatuses.

### BACKGROUND

Pickleball is a paddle sport which is engaged in by players of a wide range of ages and skill levels. Players tend to frequently engage in games. Pickleball paddles are available in a wide range of quality.

As a pickleball paddle continues to be used, its striking surfaces may lose their capability to effect spin. This can be due to small fibers from the pickleball balls that strike the paddle accumulating on the striking surfaces. Such small fibers can clog the grooves on the striking surface. When the grooves are gradually clogged up with small plastic fibers from repeated ball strikes, the paddle may have diminished capability to transfer spin to balls being hit. Also, when the grooves fill up, the paddle may start to look unclean.

Pickleball paddle cleaner devices that can be conveniently accessed and efficiently used are desired.

### SUMMARY OF EXAMPLE EMBODIMENTS

According to one embodiment, a pickleball paddle cleaning apparatus includes a first cleaning pad arranged on a first plate, a second cleaning pad arranged on a second plate, and a pressure-exertion mechanism configured to move at least one of the first plate and the second plate so that the first cleaning pad and the second cleaning pad simultaneously contact a front striking surface and a back striking surface, respectively, of a pickleball paddle that is temporarily inserted between the first cleaning pad and the second cleaning pad.

The pressure-exertion mechanism may be configured to elastically move the first cleaning pad and the second cleaning pad apart when the pickleball paddle is inserted into the opening and automatically move back towards each other when the pickleball paddle is removed from the opening. The pressure-exertion mechanism may be responsive to the manual moving of the first and/or second plates.

In some examples, the pressure-exertion mechanism may include one or more spring devices that are incorporated between said first and second plates and configured to exert a predetermined pressure on the inserted pickleball paddle. In some examples, the pressure-exertion mechanism may include one or more spring devices incorporated on one of the first and second plates to enable the one of the first and second plates to move under pressure exerting a predetermined pressure on the inserted pickleball paddle. In some examples, the pressure-exertion mechanism may include a ratchet device attached to at least one of said first and second plates and configured to enable at least one of the first and second plates to be located at different levels of separation

The first cleaning pad and the second cleaning pad may be parallel to each other. The first cleaning pad and the second cleaning pad each may comprise a respective flat, rectangular rubber cleaning surface, and/or at least one may have a textured surface configured for enhanced cleaning effectiveness. At least one of the first and second cleaning pads may be coated with a micro-abrasive material for removing stubborn dirt. In some examples, at least one of the first and second cleaning pads may include an infused cleaning agent received through an infusing component that is part of the paddle cleaning apparatus.

In some examples, the paddle cleaning apparatus may include one or more handles, at least one of the first and second plates may include a built-in brush for cleaning a grip area of the pickleball paddle, and/or a compartment integrated into one of the first and second plates for storing cleaning solution and/or a replacement brush.

In some examples, the pickleball paddle cleaner may include an electronic circuit configured to control the pressure-exertion mechanism and/or the first and second cleaning pads, when the pickleball paddle is located in the opening, to simultaneously clean the front and back striking surfaces of the pickleball paddle.

In some examples, the electronic circuit may further be configured to detect a presence of the pickleball paddle in the opening, and in response to the detecting, automatically control the pressure-exertion mechanism to move at least one of the first cleaning pad and the second cleaning pad to make contact with the front striking surface and the back striking surface, respectively, of the pickleball paddle located in the opening.

In some examples, the electronic circuit may be further configured to control the contact of the first cleaning surface and the second cleaning surface in accordance with a type of pickleball paddle. The electronic circuit may be further configured to access a paddle type table data structure in memory and perform the controlling the contact in accordance with content in the paddle type table data structure.

The automatically controlling the pressure-exertion mechanism to move at least one of the first cleaning pad and the second cleaning pad to make contact with the front striking surface and the back striking surface, respectively, of the pickleball paddle located in the opening may include automatically controlling at least one of a first movement of the first and second cleaning pads towards each other and a second movement of the first and second cleaning pads parallel to each other.

In another examples, the automatically controlling a mechanism to move at least one of the first cleaning pad and the second cleaning pad to make contact with the front striking surface and the back striking surface, respectively, of the pickleball paddle located in the opening may include automatically controlling a first movement of the first and second cleaning pads towards each other and a second movement of the first and second cleaning pads parallel to each other. The electronic circuit is further configured to control the first movement and/or the second movement in accordance with one or more parameters in a lookup table. The one or more parameters include a pressure level and a cleaning pad movement distance.

In some examples, the electronic circuit may include at least one of a pressure sensor and a paddle presence detection sensor.

In some examples, the pickleball paddle cleaning apparatus may further include a user-interface display and the electronic circuit is further configured to display usage instructions.

In some examples, the pickleball paddle cleaning apparatus's electronic circuit may further include a timer and the first movement and/or the second movement may be controlled in accordance with the timer. Alternatively or additionally, the pressure-exertion mechanism is controlled in accordance with the timer.

In some examples, the pickleball paddle cleaning apparatus may further include one or more vibration generation devices configured to vibrate the paddle and/or the plates.

In some examples, the pickleball paddle cleaning apparatus may further include one or more suction and/or blowing devices.

### BRIEF DESCRIPTION OF THE DRAWINGS

Some features are shown by way of example, and not by limitation, in the accompanying drawings. In the drawings, like numerals may reference similar elements.

FIG. 1A shows an example pickleball court, in which embodiments of the present disclosure may be applied.

FIG. 1B shows another view of a pickleball court.

FIGS. 2A and 2B show examples of conventional pickleball paddles.

FIG. 3 shows example pickleball paddle specifications according to the United States Pickleball Association.

FIG. 4A and FIG. 4B illustrate a pickleball paddle cleaning apparatus according to some embodiments of the present disclosure.

FIG. 5 illustrates a pickleball paddle cleaning apparatus having a flexible attachment device between the upper and lower plates, according to some embodiments of the present disclosure.

FIG. 6 illustrates a portable pickleball paddle cleaning apparatus according to some embodiments of the present disclosure.

FIG. 7 illustrates a pickleball paddle cleaning apparatus that also provides grip cleaning, according to some embodiments of the present disclosure.

FIG. 8 illustrates an electronically controllable pickleball paddle cleaning apparatus according to some embodiments of the present disclosure.

FIG. 9 illustrates another electronically controllable pickleball paddle cleaning apparatus according to some embodiments of the present disclosure.

FIGS. 10A and 10B illustrate other electronically controllable pickleball paddle cleaning apparatuses according to some embodiments of the present disclosure.

FIG. 11 illustrates a pickleball paddle cleaning apparatus with a ratchet mechanism to control the height of the opening between the cleaning pads according to some embodiments of the present disclosure.

FIG. 12 illustrates another pickleball paddle cleaning apparatus with a ratchet mechanism according to some embodiments of the present disclosure.

### DETAILED DESCRIPTION OF EXAMPLE EMBODIMENTS

In the following description, numerous specific details are set forth in order to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

This disclosure relates to “Pickleball,” a game that has in recent years seen a massive increase in popularity among all age groups of players, including among senior citizens. Pickleball is a game that can be described as combining aspects of tennis, badminton, and ping-pong. It is played on a badminton-sized court, with paddles and a ball similar to a wiffle ball, but slightly smaller in size. The net used in pickleball is similar to a tennis net in some ways, but is lowered at the center.

Pickleball has recently become very popular and is played both indoors and outdoors, as either doubles or singles. The rules are relatively simple and the game is easy for beginners to learn. However, among skilled players, pickleball can develop into a quick, fast-paced, and competitive game.

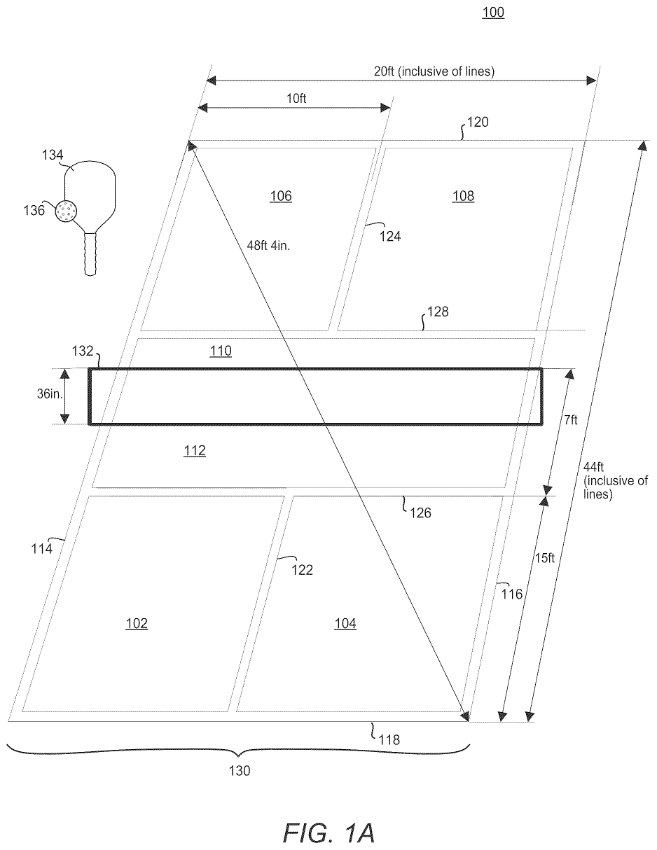

FIG. 1A shows an example pickleball court 100 that includes a pickleball playing surface 130 and a pickleball net 132. The playing surface 130 comprises two left serve areas 102 and 108, two right serve areas 104 and 106, and two non-volley areas 110 and 112, with one of the left serve areas, one of the right serve areas, and one of the non-volley areas being on each side of the pickleball net 132. The net is 36 inches tall at the edges, and lowered to 34 inches in the middle. The areas 102-112 are defined by baselines 118 and 120 each 20 feet, sidelines 114 and 116 each 44 feet, center lines 122 and 124 each 15 feet, and non-volley lines 126 and 128 each the same size as a baseline. Each of the lines may be 2 inches wide. The term “court line” is used in this disclosure to refer to any sideline, baseline, centerline or non-volley line on the pickleball court. Non-volley areas 110 and 112, each extending 7 feet from the net, are also referred to as the “kitchen”.

The game of pickleball is played with a pickleball paddle 134 and pickleball ball 136. The ball 136 is typically made of plastic and has a 3-inch diameter. Similar to a wiffleball, the ball 136 has through holes throughout the surface. Different types (e.g., with different levels of hardness and different sizes of the through holes) may be used for playing the game on the various types of pickleball courts (e.g., indoor, outdoor, hard surface, soft surface etc.).

Pickleball can be played as singles or doubles, and is most commonly played as doubles. Each point begins with an underarm serve. The serve is performed diagonally beginning at the right-hand service square. A valid serve sends the ball from one left serve area to the other left serve area or from one right serve area to the other right serve area. The serve must clear the non-volley-zone. The serve must bounce before being hit by the receiver. The return of serve must also bounce before being hit (this is known as the 2 bounce rule). After the serve and the return of the serve, the ball can land anywhere on the opposite side of the playing surface 130. Volleys can only be performed outside of the non-volley zone. Volleys, that is, hitting the ball in the air without first letting it bounce, can only be made after the 2 bounce rule has been followed. However, if the ball is hit from within the kitchen, then it cannot land in the kitchen on the other side of the net.

A fault is any action that stops play due to a rule violation. A fault by the receiving team results in the servers earning a point. A fault by the serving team results in the server's loss of service and/or side out. A fault is committed when the serve touches any part of the non-volley zone (including the line) or the ball is hit out of bounds.

Pickleball games are typically played without a referee and are self-judged. Each player makes the line calls as to whether the ball is in or out when the ball contacts the playing surface on that player's side. The game continues to at least 11 points and requires a 2-point difference for a win. FIG. 1B shows another view of a pickleball court.

As noted above, pickleball is played by people of all ages and all skill levels. It is important that pickleball organizations provide as many options as possible to facilitate enjoyable play among, especially, groups of recreational players who may need (or prefer) pickleball paddles with larger surface to assist with improving their ability to return the ball and with arrangements of the striking surface and/or handle of the paddles to provide a more comfortable grip and/or ability to make contact with the ball.

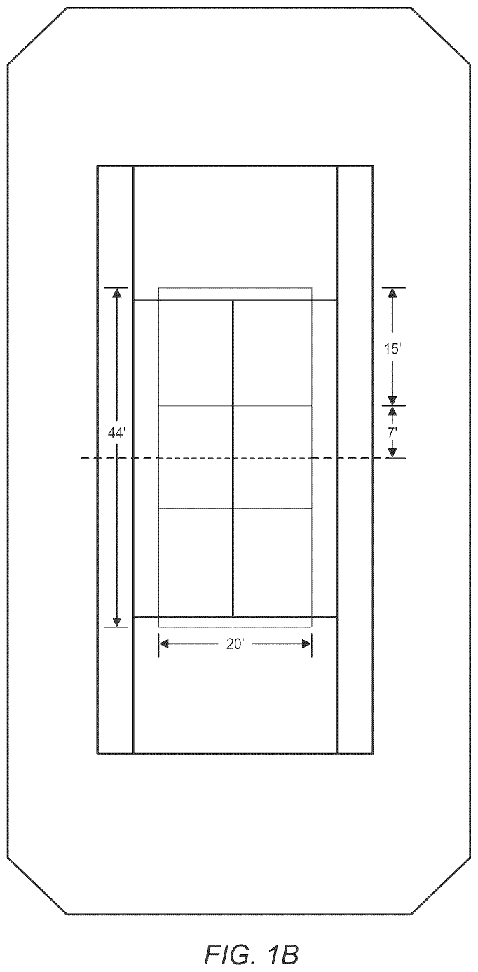

A conventional pickleball paddle is shown in FIG. 2A. In some example embodiments, as shown for example in FIG. 2A, a pickleball paddle 200 may comprise a striking blade 202 and a handle 204 connected to the striking blade. A grip 206 may wrap around a portion of the handle 204 and may comprise of a material that is more comfortable and/or provides better control of the paddle. The grip 206 is the portion of the handle that is intended to be held by the player during play (e.g., to strike and return a ball during play). The striking blade 202 comprises two striking surfaces 203, a core sandwiched between the striking surfaces, and, optionally, a frame (also referred to as an edge) 208 surrounding the striking surfaces 203. A striking surface 203 may also be referred to as a face of the striking blade 202 and is intended to be the portion of the striking blade 202 with which to strike the pickleball ball. During a pickleball game, based on the ball position and/or player position on the pickleball court, the player may use either the front face or the back face of the striking blade (e.g., corresponding to the front and back of the pickleball paddle, respectively) for any shot. The core of the striking blade may be constructed from materials such as, for example, hardened rubber, plastic, rubber/plastic compound, polymer, aluminum, honeycomb composite, etc., The striking surface 203 may comprise one or more layers of materials such as, for example, hardened rubber, plastic, rubber/plastic compound, fiberglass, carbon fiber, graphite, etc., that are conducive to striking/returning the pickleball ball and/or controlling the behavior of the ball. The striking surface 203 may be configured with a particular hardness (e.g., using the same or different material or material combination as in the rest of the striking surface) in an area referred to as “sweet spot” intended to provide the primary area of contact with the pickleball. The frame 208 may be constructed with a wood, plastic and/or hard rubber or compound thereof to encompass and provide support to the striking surface. The frame 208 may be integrated with or connected to the handle 204 at a connection area (also referred to as a connection part or connection point). The handle 204 may be the lower portion of a part/member (e.g., constructed of the same or different material(s) as the handle 204) that extends to the top of the striking blade (e.g., to the frame 208 at the top of the striking blade) or part way through the middle/core of the striking blade, and may be integrated/connected with the frame 208 in the connecting area (connecting part).

In a conventional pickleball paddle such as that shown in FIG. 2A, the entire paddle has the same center axis. That is, a center axis of the striking blade 202 and the center axis 212 of the handle 204 are parallel and are aligned with each other. Some pickleball paddles may include a butt cap 205 affixed to the bottom of the handle 204.

FIG. 2B shows two examples of commonly available pickleball paddles. The example pickleball paddle on the left side has a more elongated striking blade than the example paddle on the right side, providing a larger striking surface. Both example pickleball paddles in FIG. 2B, similar to that in FIG. 2A, has an edge that is of a concave shape on either side (left and right) of the handle and then curves upward before extending up in a straight line. In each example paddle shown in FIG. 2B the center axes (not shown in FIG. 2B) of the striking blade and the handle are the same.

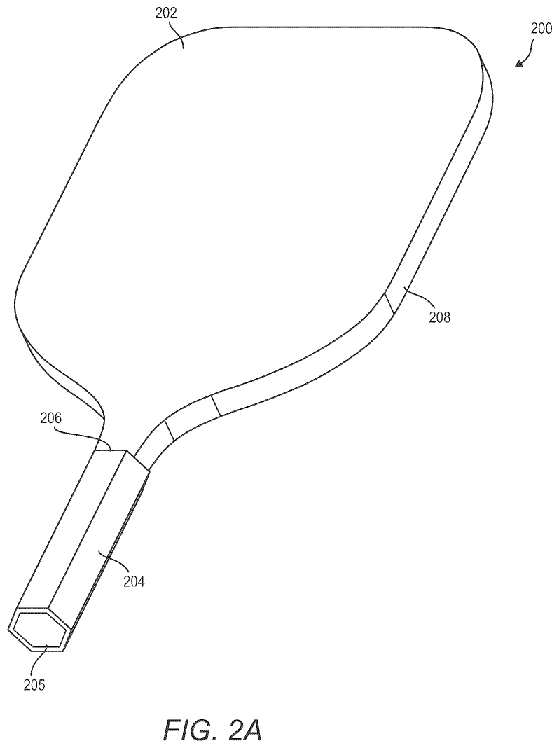

FIG. 3 shows example pickleball paddle specifications and standards according to USA Pickleball—the United States Pickleball Association. The current USA Pickleball specifications require that the combined length and width of a pickleball paddle cannot exceed 24 inches. The illustrated example paddle specification shows a paddle shape that can provide for a total length (handle and striking blade) of 15.5″-17″ inches and a width of 7″-8.25″. The paddle length may not exceed 17 inches (43.18 cm). Not mandated by USA Pickleball, but illustrated in FIG. 3 for an example pickleball paddle, are a thickness of 0.5″-0.625″ of the striking blade, a thickness of 1.25″ at the bottom of the handle, and a length of 4″-5.5″ of the handle. The side profile view at the bottom of the figure illustrates the profile view from the long side of the example paddle, and the side profile view shown on the right illustrates the profile view from the top-side of the paddle.

The handle must be an extension of the paddle face and may not exceed 5 inches (12.7 cm) in length. The handle must be an integral part of the paddle face. It should not have any separate components or extensions beyond the permitted length. The handle should have a smooth surface without any protrusions, attachments, or features that could cause injury to players or interfere with gameplay. The handle, like the rest of the paddle, must be constructed of approved materials. Common materials include wood, composite materials, or graphite.

As a pickleball paddle continues to be used, its striking surfaces may lose their capability to effect spin. This can be due to small fibers from the pickleball balls that strike the paddle accumulating on the striking surfaces. Such small fibers can clog the grooves on the striking surface. When the grooves are gradually clogged up with small plastic fibers from repeated ball strikes, the paddle may have diminished capability to transfer spin to balls being hit. Also, when the grooves fill up, the paddle may start to look unclean.

Pickleball paddle cleaners are available as cleaning pads that are designed to be applied to paddle striking surfaces, or as sprays that can be sprayed on the striking surfaces and/or handle/grip areas. The pad type of cleaners, most frequently made of rubber or rubber compounds, are popularly used to clean carbon fiber paddles. Spray cleaners are popularly used for smooth surface paddles. Spray cleaners are not used on carbon fiber paddles because the spray, often a combination of water, cleansers and oils, can spoil the paddle's striking surface.

Pickleball paddle cleaning pads, sometimes known as “paddle erasers”, are available in the market. A cleaning pad may include a soft rubber compound that enables, when the cleaning pad is manually applied to the pickleball paddle surfaces, remove ball residue, dirt, and minor scratches off of the paddle surfaces. Some of the cleaning pads may include proprietary blends of soft rubber. The cleaning pads are often sized so that they can easily be held in one hand and run back and forth over each side of the pickleball paddle surface to clean. The cleaning pad size is also convenient for purposes of being carried in the pickleball paddle/ball bags of each player, or simply enable a player to carry it to the pickleball court.

The cleaning pads are typically individually owned, relatively expensive, and are often lost due to misplacement. Cleaning sprays are usually more economical, but they can quickly diminish the quality of paddle surface by getting the cleaning mix into the paddle surface's grooves.

There are currently no known accessible cleaning options that a pickleball court provider can provide as a value added service. A fast, economical, accessible, and reliable pickleball paddle cleaning option is needed.

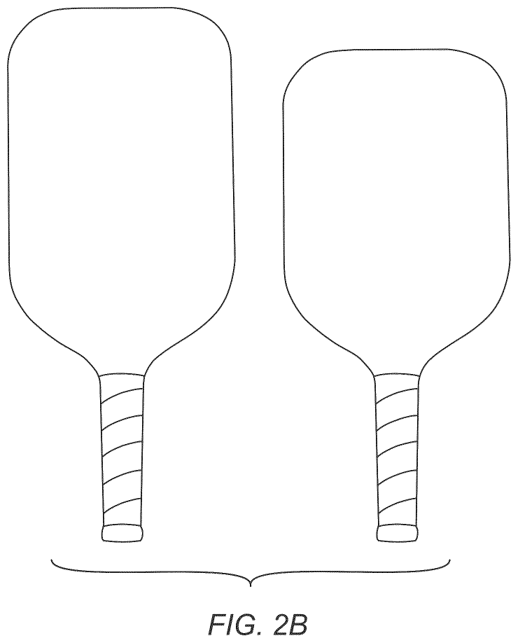

FIG. 4A and FIG. 4B illustrate a pickleball paddle cleaning apparatus 402 according to some embodiments of the present disclosure. Pickleball paddle cleaning apparatus 402 comprises two plates 404 and 406 that are arranged in parallel to each other. Each plate 404 and 406 has, on the side that is facing the other, a cleaning pad (pads 408 and 410) attached thereto.

In one arrangement of apparatus 402, the plates 404 and 406 are arranged in a horizontal direction and plate 404 and its cleaning pad 408 are lower than plate 406 and its cleaning pad 410. The plates 404 and 406 and/or cleaning pads 410 and 408 may be arranged such that, when no pickleball paddle is inserted into apparatus 402, there is either no spacing, or only an opening of a minimum height, between the two cleaning pads 408 and 410. For example, when no pickleball paddle is present between them, the faces of cleaning pads 408 and 410 may be in light/soft contact with each other. Alternatively, when no pickleball paddle is present in the opening between them, the opening between cleaning pads 408 and 410 may have a height less than the height (thickness) of a pickleball paddle. The design intention is to, when a pickleball paddle is inserted into the opening between the cleaning pads, have each cleaning pad 408 and 410 rub against the paddle surface with sufficient pressure to extract ball residue, dust, grime and/or other extraneous substances from the paddle striking surfaces.

In some embodiments, plate 404 and another plate 416 may be immovably attached to a container structure or attachment structure. For example, plates 404 and 416 may be attached to a wall, post or other, vertical or near vertical, straight structure by bolting them to the structure at their respective left ends. In some other embodiments, plates 404 and 416 are attached to structures or portions of structures that are in a horizontal direction by, for example, attaching a bottom side of plate 404 and an upper side of plate 416 to the structure(s).

Plate 406 may be connected to plate 416 via one or more flexible attachment devices 412 and 414. The flexible attachment devices 412 and 414 may each include a spring (e.g., compression spring) mechanism that enables the plate 406 to move in relation to static plates 416 and 404 in a vertical direction. A railing or other such mechanism 417, for example. arranged in the vertical plane between plates 404 and 416, may be provided such that the plate 406 can move up and down in relation to plate 416.

When a pickleball paddle 200 is inserted into the opening between cleaning pads 408 and 410, plate 406 moves upwards (towards plate 416 and away from plate 404) under the upward pressure exerted on cleaning pad 410 and plate 406 by the paddle 200. The movement of plate 406 is due to the upward pressure generated by the insertion of paddle 200 becomes greater than the downward pressure exerted on plate 406 by the flexible attachment devices 412 and 414.

FIG. 4A illustrates the paddle cleaning apparatus 402 before pickleball paddle 200 is inserted into the opening between cleaning pads 408 and 410. FIG. 4B illustrates the apparatus 402 when the paddle 200 has been inserted into the opening. FIG. 4A illustrates that the flexible attachment devices 412 and 414 are extended to a longer height than in FIG. 4B. Apparatus 402 may be used to simultaneously clean the front and back striking surfaces of paddle 200 by the user holding the paddle's handle and pushing the striking blade in between cleaning pads 408 and 410. The user may maintain the hold on the handle and move the paddle 200 so that the striking blade moves in the opening between cleaning pads 408 and 410 in any direction (horizontally, vertically, diagonally, circularly, etc.) in a manner that all areas of the striking surfaces and/or only certain areas (e.g., certain areas with a higher amount of dirt, etc.) are passed one or more times between the cleaning pads 408 and 410. The friction generated when the cleaning pads contact the striking surfaces cause the residue and dirt to be removed. When the paddle striking surface is removed away from between cleaning pads 408 and 410, the plates 404 and 406 return to original positions and cleaning pads 408 and 410 elastically return to their original height and shape.

Each of the plates 404, 406 and 416 may be constructed from a material or materials such as wood, plastic, rubber and/or a combination thereof, and is designed to remain firm (e.g., to remain straight) when the apparatus 402 is being used. The length, width and/or thickness of each of the plates may be dimensioned in any manner that is sufficient to attach the cleaning pads.

In some embodiments, the cleaning pads are flat with a preconfigured thickness and may be rectangular. The cleaning pads may be of any size such that in different apparatus 402 implementations, having smaller (e.g., smaller cleaning area) cleaning pads will require the user to move the paddle more in order to have the entire striking surface cleaned by the pads and having larger cleaning pads will require the user to do less moving of the paddle to have the entire striking surface cleaned. The cleaning pads 408 and 410 may be formed from a rubber compound, and may be attached to the respective plates in a replaceable manner. The cleaning pads may have some flexibility and/or elasticity, but are attached to the plates in such a manner that both cleaning pads press on the paddle striking surfaces with sufficient pressure to cause ball residue, dirt and/or minor scratches to be removed from the paddle striking surfaces. In some embodiments, the cleaning pads have a grooved and/or textured surface configured for enhanced cleaning effectiveness. In some embodiments, one or more of the cleaning pads are coated with a micro-abrasive material for removing stubborn dirt.

In some embodiments, apparatus 402 may be a movable (or portable) apparatus where plates 404 and 416 do not move in relation to each other, but the entire apparatus can be moved. For example, plates 404 and 416 can be affixed to opposite ends of the internal wall of apparatus 402. In some embodiments, the apparatus 402 may be attached to a wall or similar straight structure 419 by bolting the left ends of plates 404 and 416, and railing 417, to the wall or other external structure 419.

It should be noted that although the above description primarily referred to a configuration in which the plates are in horizontally-oriented positions, embodiments are not limited to any particular orientation directions. For example, the apparatus 402 may be oriented in any direction that permits a user to conveniently insert a pickleball paddle between the cleaning pads. Also, although the description primarily addresses pickleball paddles being inserted into apparatus 402 in the lengthwise orientation of the apparatus (e.g., so that the length of the paddle is oriented in the same direction of the length of the apparatus 402) embodiments are not limited thereto. For example, in some embodiments, the pickleball paddle may be inserted between the cleaning pads in any orientation direction that is convenient to the user.

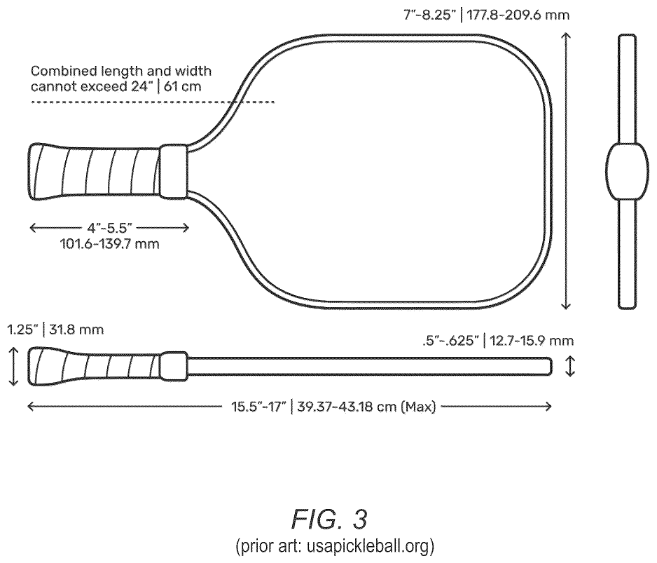

FIG. 5 illustrates another pickleball paddle cleaning apparatus 502 according to some embodiments of the present disclosure. Similar to apparatus 402 in some aspects, apparatus 502 includes plates 504 and 506 that have respectively attached cleaning pads 508 and 510 arranged so that they face each other. Plates 504 and 506 may be similarly formed as plates 404 and 406, and cleaning pads 508 and 510 may be similarly formed as cleaning pads 408 and 410. A paddle, such as paddle 200, can be cleaned by inserting its striking blade into the opening between the cleaning pads 508 and 510.

Apparatus 502 includes a flexible attachment device 518 connected to plates 504 and 506 at or near the opposite end from where the paddle is to be inserted for cleaning. The flexible attachment device 518 may include one or more springs (e.g., compression springs) that hold plates 504 and 506 at a distance from each other, when no paddle is present in the apparatus 502, so that cleaning pads 508 and 510 are either touching each other (i.e., no opening exists between the cleaning pads 508 and 510) or have an opening of which the height is less than the thickness of a pickleball paddle striking blade. In some embodiments, the flexible attachment device 518 may comprise a ratchet device attached to at least one of the plates, configured to enable at least one of the plates to be located at different levels of separation.

When a paddle 200 (not shown in FIG. 5) is inserted between the cleaning pads 508 and 510, the back paddle surface and a front paddle surface (or lower and upper paddle surfaces) are simultaneously cleaned respectively by cleaning pads 508 and 510. The insertion of the paddle pushes the cleaning pads and the plates 504 and 506 vertically apart from each other causing the flexible attachment device 518 to extend. When the paddle is removed, the flexible attachment device automatically contracts thereby moving the cleaning pads 508 and 510 and plates 504 and 506 to their original positions.

In some embodiments, apparatus 502 may include a vertical wall structure 519 to which plates 504 and 506 are attached. Plate 504 may be fixedly attached, which plate 506 may be attached to a vertical railing 517 on the wall structure 519. The vertical railing 517 enables movement of plate 506 in relation to the static plate 504 when a paddle is inserted or removed from between cleaning pads 508 and 510.

The apparatus 502 may be freestanding (i.e., without being attached to another structure) or may be attached to another structure. For example, apparatus 502 may be attached to an external structure (e.g., wall or post) by bolting it, by way of the left edge of plate 504 and/or a vertical wall structure 519 to which the plates and railing are attached, to the external structure.

In some embodiments, the user may manually press one or both plates 504 and 506 towards each other so as to have cleaning pads 508 and 510 make contact with a paddle's striking surfaces. The player may place the paddle between the cleaning pads 508 and 510, and thereafter manually press one or both plates to clean the pickleball paddle's striking surfaces by inserting the striking blade between cleaning pads 508 and 510.

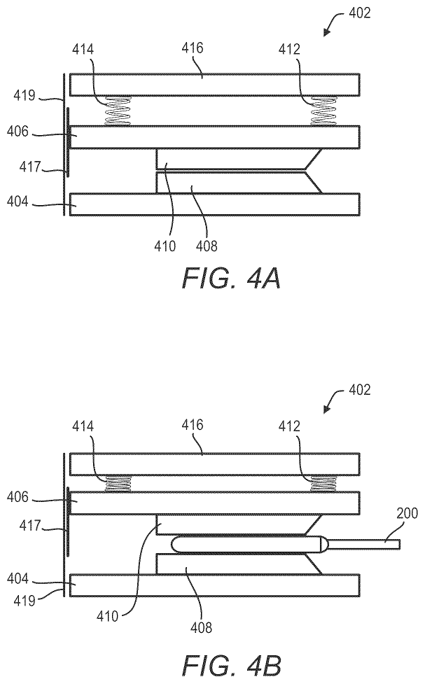

FIG. 6 illustrates another pickleball paddle cleaning apparatus 602 according to some embodiments of the present disclosure. Similar to apparatus 402 in some aspects, apparatus 602 includes plates 604 and 606 having respectively attached cleaning pads 608 and 610 arranged so that they face each other. Plates 604 and 606 may be similarly constructed as plates 404 and 406, and cleaning pads 608 and 610 may be similarly constructed as cleaning pads 408 and 410. A flexible attachment device 618, which connects plates 604 and 606, may be similar in construction and operation to the flexible attachment device 518. A railing or other mechanism 617, similar to the railing or other mechanism 417, may be provided to enable smooth movement of plate 606. A paddle, such as paddle 200, can be cleaned by inserting the paddle into the opening between the cleaning pads 608 and 610.

Paddle cleaning apparatus 602 includes a handle 620 that may be attached to the vertical wall structure 621 and/or flexible attachment device 618. The handle 620 may be constructed of any material, size and/or shape that is amenable for the apparatus 602 to be carried or easily handled by a user with one hand, while the other hand manipulates a paddle into the opening between cleaning pads 608 and 610 to clean the paddle striking surfaces.

In some embodiments, the apparatus 602 may have a compartment integrated into one of the plates for storing cleaning solution and/or a replacement brush.

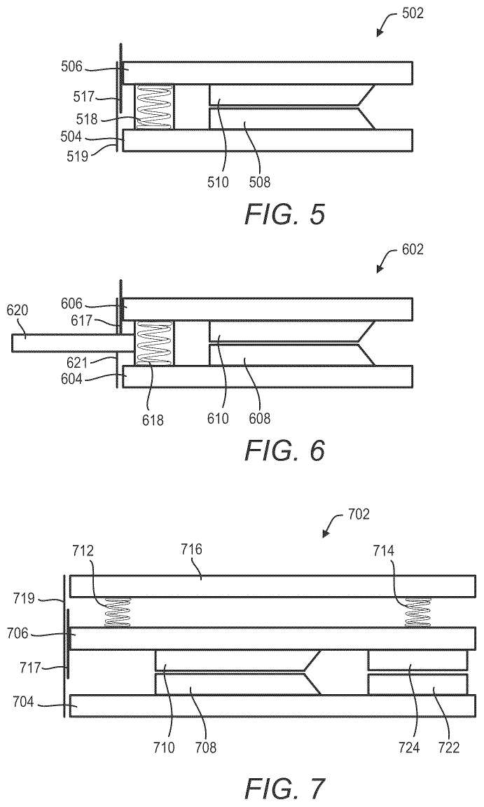

FIG. 7 illustrates another pickleball paddle cleaning apparatus 702 according to some embodiments of the present disclosure. Similar to apparatus 402 in some aspects, apparatus 702 includes plates 704 and 706 having respectively attached cleaning pads 708 and 710 arranged so that they face each other. Plates 704 and 706 may be similarly constructed as plates 404 and 406, and cleaning pads 708 and 710 may be similarly constructed as cleaning pads 408 and 410. The flexible attachment devices 712 and 714 may be similar in construction and operation to the flexible attachment devices 412 and 414. A railing or other mechanism 717, in a similar manner to railing or other mechanism 417, may be attached to a structure 719 and enables plate 710 to move vertically in relation to plates 704 and 716. A paddle, such as paddle 200, can be cleaned by inserting the paddle into the opening between the cleaning pads 708 and 710.

In some embodiments, paddle cleaning apparatus 702 may include a flexible attachment device connecting plates 704 and 706 to each other, in addition to, or in place of, the flexible attachment devices 712 and 714.

Paddle cleaning apparatus 702 includes, in addition to cleaning pads 708 and 710 that are configured to clean paddle surfaces, one or more cleaning devices 722 and 724 to clean the grip area of the paddle.

In some embodiments, the grip area cleaning devices 722 and/or 724 may include a brush or cloth like material with a cleaning solution. In some other embodiments, grip area cleaning devices 722 and/or 724 comprises an irradiation chamber.

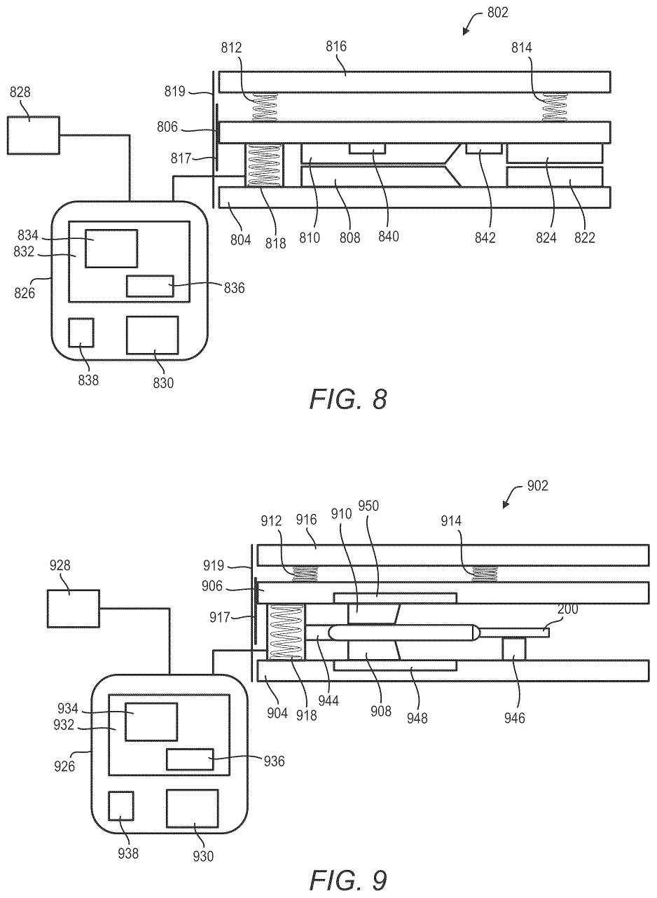

FIG. 8 illustrates another pickleball paddle cleaning apparatus 802 according to some embodiments of the present disclosure. Similar to apparatus 402 in some aspects, apparatus 802 includes plates 804 and 806 having respectively attached cleaning pads 808 and 810 arranged so that they face each other. Plates 804 and 806 may be similarly constructed as plates 404 and 406, and cleaning pads 808 and 810 may be similarly constructed as cleaning pads 408 and 410. The flexible attachment devices 812 and 814 may be similar in construction and operation to the flexible attachment devices 412 and 414. A railing or other mechanism 817, in a similar manner to railing or other mechanism 417, may be attached to a structure 819 and enables plate 806 to move vertically in relation to plates 804 and 816. A paddle, such as paddle 200, can be cleaned by inserting the paddle into the opening between the pads.

In some embodiments, paddle cleaning apparatus 802 may include a flexible attachment device 818 connecting plates 804 and 806 to each other, in addition to, or in place of, the flexible attachment devices 812 and 814. Each of the flexible attachment devices may include a compression spring or the like. In some embodiments, the flexible attachment device 818 may comprise a ratchet device attached to at least one of the plates, configured to enable at least one of the plates to be located at different levels of separation.

Paddle cleaning apparatus 802 may include one or more cleaning devices 822 and 824 to clean the grip area of the paddle, which may be similar in construction and operation to devices 722 and 724 described above.

Paddle cleaning apparatus 802 may be electronically controllable. An electronic circuit 826 may be connected to the paddle cleaning apparatus 802 and may control its operation such as, for example, an amount of pressure with which cleaning pads 808 and 810 are applied to paddle striking surfaces, type and/or amount of cleaning solution to be used with the pads for applying to a paddle surface, type and/or amount of cleaning solution to be used with the cleaning devices for the grip area of the paddle, and/or a time duration for cleaning the paddle in the apparatus 802.

A display device 828 may be connected to the electronic circuit 826 to display usage instructions and status messages. The electronic circuit 826 includes a processor 830 and a memory 832. The electronic circuit may also include a timer 838.

The memory 832 may store instructions and/or program code 836 for controlling the operation of apparatus 802. In some embodiments, memory 832 may store a configuration database (e.g., a table data structure) 834 that specifies preconfigured cleaning and/or device operation parameters for a plurality of types of pickleball paddles.

Apparatus 802 may include one or more pressure sensors 840 and/or one or more paddle presence detectors 842. One or more pressure sensors 840 may be attached to, or embedded in, a cleaning pad and/or a flexible attachment device (e.g., 812, 814 and/or 818) to sense the pressure levels when a paddle is inserted, or removed from, between the cleaning pads and convey the detected pressure levels to the electronic circuit 826. One or more paddle presence detectors 842 may be arranged in an area, for example, between the cleaning pads 808/810 and grip cleaning devices 822/824 so that it can detect the presence of a paddle's handle when the paddle is inserted with its surface between cleaning pads 808 and 810, and grip area between devices 822 and 824.

In some embodiments, the user is prompted on display device 828 to begin the cleaning process by selecting a type, brand, model, and/or size of the pickleball paddle. The user may enter the relevant information by way of a keyboard and/or touchscreen. The electronic circuit 826 and processor 830 are configured to determine, based on the user-provided information and corresponding information from the preprogrammed database 834, determines a preferred pressure level to be imposed on the paddle striking surface.

When the electronic circuit 826 detects the presence of a paddle in the apparatus 802, the flexible attachment device and/or plate 806 are moved to impose the determined preferred level of pressure while monitoring the pressure level with the pressure sensor(s) 840. When the electronic circuit 826 detects, for example, by using paddle presence detector sensor 842, that the paddle has been removed from the apparatus 802, the flexible attachment device 818 and/or plate 806 are moved to release the imposed pressure and to move the plate 806 to its default position.

In some embodiments, the electronic circuit 826 and processor 830 may also determine a preferred time interval for the user to keep the paddle between cleaning pads 808 and 810 for an ideal level of cleaning. The preferred time may be determined in accordance with the paddle type. The electronic circuit 826 and processor 830 may, using the timer 838 and display device 828, guide the user to keep and/or move the paddle between the cleaning pads 808 and 810.

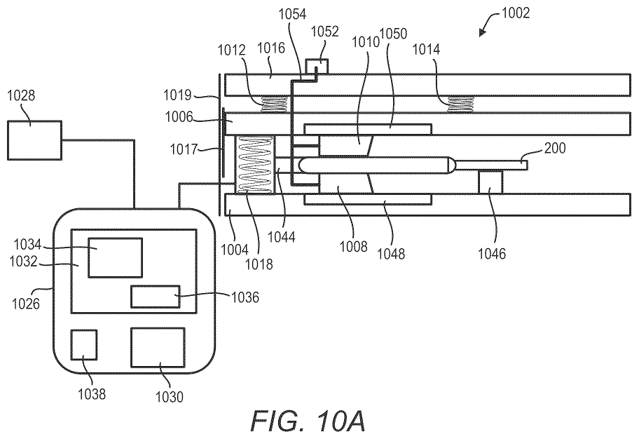

FIG. 9 illustrates another pickleball paddle cleaning apparatus 902 according to some embodiments of the present disclosure. Similar to apparatus 402 in some aspects, apparatus 902 includes plates 904 and 906 having respectively attached cleaning pads 908 and 910 so that they face each other. Plates 904 and 906 may be similarly constructed as plates 404 and 406, and cleaning pads 908 and 910 may be similarly constructed as cleaning pads 408 and 410. The flexible attachment devices 912 and 914 may be similar in construction and operation to the flexible attachment devices 412 and 414. A railing or other mechanism 917, in a similar manner to railing or other mechanism 417, may be attached to a structure 919 and enables plate 906 to move vertically in relation to plates 904 and 906. A paddle, such as paddle 200, can be cleaned by inserting the paddle into the opening between the pads.

In some embodiments, paddle cleaning apparatus 902 may include a flexible attachment device 918 connecting plates 904 and 906 to each other, in addition to, or in place of, the flexible attachment devices 912 and 914.

Paddle cleaning apparatus 902 may include one or more cleaning devices 922 and 924 to clean the grip area of the paddle, which may be similar in construction and operation to devices 922 and 924 described above.

The electronic circuit 926, display device 928, processor 930, memory 932, and timer 938 may be similar to the corresponding components 826, 828, 830, 832 and 838 described in relation to apparatus 802.

Different from apparatus 802 though, apparatus 902 is configured to laterally move cleaning pads 908 and/or 910 over an inserted paddle's surfaces. A paddle holder attached to the flexible attachment device 918 may be configured to firmly hold the paddle 200 while the cleaning pads 908 and/or 910 are moved laterally over the paddle striking surface(s). The cleaning pads may be configured to move by way of one or more railings 948 and 950 attached respectively to the plates 904 and 906. One or more motors (not shown in the figure), operable in forward and reverse directions, may be controlled by the electronic circuit 926 to move the cleaning pads 908 and/or 910.

A support 946 may be attached to plate 904 to support grip area that can facilitate the paddle 200 to be held firmly in a parallel manner to the plates/pads so that the cleaning can be appropriately performed.

In some embodiments, an electronic circuit 926 is connected to the apparatus 902 and to a display device 928. The electronic circuity 926 includes a processor 930 and a memory 932. The memory may include stored instructions 936 and a database 934 of paddle type-specific cleaning parameters. The electronic circuit 926 may also include a timer 938. The electronic circuit 926 and processor 930 may operate to control a pressure level and/or cleaning duration in a similar manner as described above in relation to FIG. 8 and electronic circuit 826. The electronic circuit 926 may also control the lateral movement of cleaning pads 908 and 910 in accordance with user-provided paddle information and/or preprogrammed information.

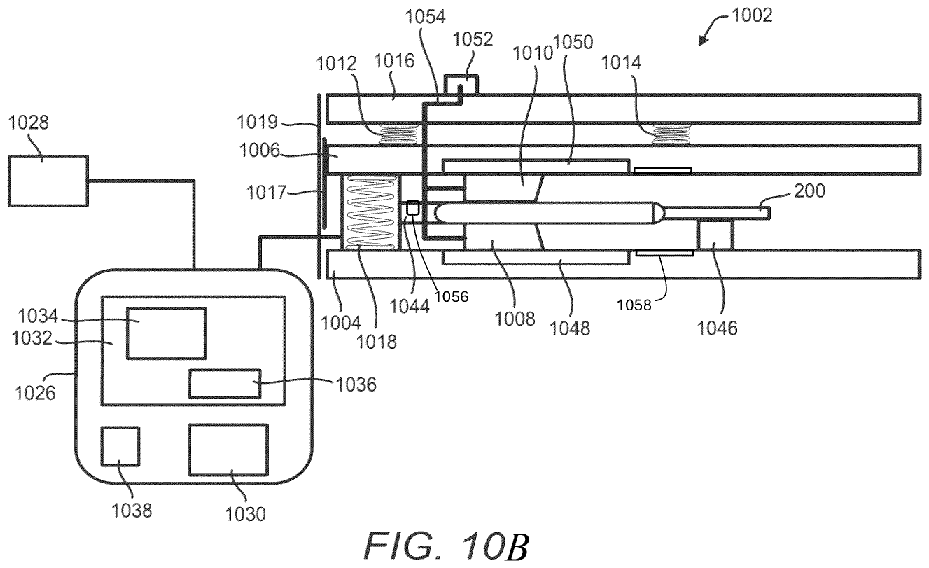

FIG. 10A illustrates another pickleball paddle cleaning apparatus 1002 according to some embodiments of the present disclosure. Similar to apparatus 402 in some aspects, apparatus 1002 includes plates 1004 and 1006 having respectively attached cleaning pads 1008 and 1010 arranged so that they face each other. Plates 1004 and 1006 may be similarly constructed as plates 404 and 406, and cleaning pads 1008 and 1010 may be similarly constructed as cleaning pads 408 and 410. The flexible attachment devices 1012 and 1014 may be similar in construction and operation to the flexible attachment devices 412 and 414. A railing or other mechanism 1017, in a similar manner to railing or other mechanism 417, may be attached to a structure 1019 and enables plate 1006 to move vertically in relation to plates 1004 and 1016. A paddle, such as paddle 200, can be cleaned by inserting the paddle into the opening between the cleaning pads 1008 and 1010.

In some embodiments, paddle cleaning apparatus 1002 may include a flexible attachment device 1018 connecting plates 1004 and 1006 to each other, in addition to, or in place of, the flexible attachment devices 1012 and 1014.

Paddle cleaning apparatus 1002 may include one or more cleaning devices 1022 and 1024 to clean the grip area of the paddle, which may be similar in construction and operation to devices 722 and 724 described above.

In some embodiments, paddle cleaning apparatus 1002 includes a vibration generating device that can vibrate the paddle striking blade and/or the cleaning pads. In the illustrated embodiment in FIG. 10, vibration generating device 1056 is attached to paddle holder 1044 and is configured to vibrate the paddle between the cleaning pads. In some embodiments, one or more vibration generating devices are attached to cleaning pads 1008 and 1010 and/or plates 1004 and 1006. The vibrations of the paddle and/or the cleaning pads can facilitate cleaning dirt from some of the harder to reach carbon-fiber grooves.

In some embodiments, a suction and/or blowing device 1058 is incorporated into one or both plates 1004 and 1006 and/or cleaning pads 1008 and 1010. Suction and/or blowing device 1056 may include an air tube and/or a vacuum.

The electronic circuit 1026, display device 1028, processor 1030, memory 1032, and timer 1038 may be similar to the corresponding components 826, 828, 830, 832 and 838 described in relation to apparatus 802.

Apparatus 1002 additionally includes a cleaning solution dispensing/infusing system that includes a cleaning solution reservoir 1052 and tubing 1054 to distribute the cleaning solution from the reservoir 1052 to the cleaning pads 1008 and/or 1010. In some embodiments, the cleaning pads are infused with the cleaning agent that is released upon contact with the paddle surface.

In some embodiments, an electronic circuit 1026 is connected to the apparatus 1002 and to a display device 1028. The electronic circuity 1026 includes a processor 1030 and a memory 1032. The memory may include stored instructions 1036 and a database 1034 of paddle type-specific cleaning parameters. The electronic circuit 1026 may also include a timer 1038. The electronic circuit 1026 and processor 1030 may operate to control a pressure level and/or cleaning duration in a similar manner as described above in relation to FIG. 8 and electronic circuit 826 and/or FIG. 9 and electronic circuity 926. The electronic circuit 1026 may also control the dispensation/infusing of the cleaning solution.

In some embodiments such as the variation of apparatus 1002 shown in FIG. 10B, during the cleaning period, the processor 1030 may control vibration devices 1056 configured to vibrate the paddle striking blade and/or vibration generating devices embedded in the cleaning pads 1008 and 1010 and/or plates 1004 and 1006 to vibrate the cleaning pads over the paddle striking surfaces in order to effect a more robust cleaning.

The electronic circuit 1026 may activate the suction and/or blowing device(s) 1058 during the cleaning process to have a vacuuming and/or blowing effect in the paddle striking surfaces to help remove/dislodge reside or dirt. The operation of the suction and/or blowing device(s) 1058 may be timed.

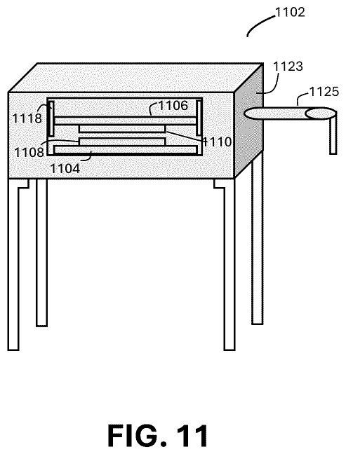

FIG. 11 illustrates a pickleball paddle cleaning apparatus 1102 according to some embodiments of the present disclosure. Apparatus 1102 comprises a rectangular container structure 1123 within which the plates and cleaning pads are arranged for cleaning pickleball paddles. The rectangular container 1123 may be of a size and a construction that allows a user to easily move apparatus 1102 and thus can be moved to various locations, for example, in a pickleball court complex.

Apparatus 1102 comprises a lower plate 1104 and an upper plate 1106 and cleaning pads 1108 and 1110 attached thereto. The construction and operation of the cleaning pads 1108 and 1110 and plates 1104 and 1106 may be similar to cleaning pads 408 and 410 and plates 404 and 406 as described in relation to FIG. 4.

Apparatus 1102 includes a flexible attachment device 1118 that comprises a ratchet mechanism. A handle 1125 can be manually operated by the user to increase or decrease the height of the opening between the cleaning pads 1108 and 1110. In the illustrated embodiment, the adjustment of the height is affected by moving the upper place 1106 to a position in the vertical range enabled by the ratchet mechanism. In some embodiments, one or both plates may be moved by a ratchet mechanism to adjust the height of the opening between the cleaning pads.

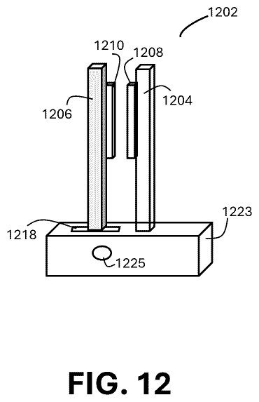

FIG. 12 illustrates another pickleball paddle cleaning apparatus 1202 according to some embodiments of the present disclosure. Apparatus 1202 comprises a base structure 1223 within which the plates and cleaning pads are arranged in a vertical orientation for cleaning pickleball paddles. The rectangular base 1223 may be of a size and a construction that allows a user to easily move apparatus 1202 and thus can be moved to various locations, for example, in a pickleball court complex.

Apparatus 1202 comprises plates 1204 and 1206 and cleaning pads 1208 and 1210 attached thereto. The construction and operation of the cleaning pads 1208 and 1210 and plates 1204 and 1206 may be similar to cleaning pads 408 and 410 and plates 404 and 406 as described in relation to FIG. 4.

Apparatus 1202 includes a flexible attachment device 1218 that comprises a ratchet mechanism. A handle 1225 can be manually operated by the user to increase or decrease the width of the opening between the cleaning pads 1208 and 1210. In the illustrated embodiment, the adjustment of the width is affected by moving the plate 1206 to a position in the horizontal range enabled by the ratchet mechanism. In some embodiments, one or both plates may be moved by a ratchet mechanism to adjust the width of the opening between the cleaning pads.

The above described embodiments are illustrative and the disclosure is not limited to the described embodiments. In some further embodiments, features of some of the described embodiments may be combined with other embodiments. For example, the cleaning solution dispensation system, the vibration generation devices, and/or suction and/or blowing devices shown in FIGS. 10A-B, or adapted versions thereof, may be included in any of the apparatuses shown in FIG. 4-8.

Embodiments of the present disclosure provide cost-effective, durable, and highly-available pickleball paddle cleaning apparatuses. For example, paddle cleaning apparatuses according to various embodiments may be used as portable devices carried by the user, movable devices that can be conveniently moved to different locations in a pickleball court, or devices that can be permanently attached to walls, posts and other such structures. Some embodiments provide for cleaning customized to the paddle type or other user-selected criteria. Such customizability may provide for more effective cleaning and reducing the risk of damage to the paddles.

The above described embodiments provide pickleball paddle cleaning apparatuses. It should be noted that embodiments of the present disclosure are not limited to paddle cleaning apparatuses that are limited to the shapes, lengths or construction materials of the paddle holding parts, strike blades, or butt caps of the pickleball paddles. Although various embodiments have been shown and described in detail, the claims are not limited to any particular embodiment or example.

1. A pickleball paddle cleaning apparatus comprising:
a first cleaning pad arranged on a first plate;
a second cleaning pad arranged on a second plate; and
a pressure-exertion mechanism configured to move at least one of the first plate and the second plate so that the first cleaning pad and the second cleaning pad simultaneously contact a front striking surface and a back striking surface, respectively, of a pickleball paddle that is temporarily inserted between the first cleaning pad and the second cleaning pad.

2. The pickleball paddle cleaning apparatus according to claim 1, wherein the pressure-exertion mechanism is configured to elastically move the first cleaning pad and the second cleaning pad apart when the pickleball paddle is inserted into the opening and automatically move back towards each other when the pickleball paddle is removed from the opening.

3. The pickleball paddle cleaning apparatus according to claim 2, wherein the pressure-exertion mechanism is responsive to the manual moving of the first and/or second plates.

4. The pickleball paddle cleaning apparatus according to claim 1, wherein the first cleaning pad and the second cleaning pad are parallel to each other.

5. The pickleball paddle cleaning apparatus according to claim 1, further comprising cleaning agent infusing component, wherein at least one of said first and second cleaning pads comprises an infused cleaning agent received through the infusing component.

6. The pickleball paddle cleaning apparatus according to claim 1, wherein at least one of said first and second cleaning pads is coated with a micro-abrasive material for removing stubborn dirt.

7. The pickleball paddle cleaning apparatus according to claim 1, wherein the pressure-exertion mechanism comprises one or more spring devices incorporated between said first and second plates and configured to exert a predetermined pressure on the inserted pickleball paddle.

8. The pickleball paddle cleaning apparatus according to claim 1, wherein the pressure-exertion mechanism comprises one or more spring devices incorporated on one of the first and second plates to enable said one of the first and second plates to move under pressure exerting a predetermined pressure on the inserted pickleball paddle.

9. The pickleball paddle cleaning apparatus according to claim 1, wherein the pressure-exertion mechanism comprises a ratchet device attached to at least one of said first and second plates, configured to enable at least one of the first and second plates to be located at different levels of separation.

10. The pickleball paddle cleaning apparatus according to claim 1, wherein at least one of the first and second plates comprises a built-in brush for cleaning a grip area of the pickleball paddle.

11. The pickleball paddle cleaning apparatus according to claim 1, further comprising an electronic circuit configured to: control the pressure-exertion mechanism and/or the first and second cleaning pads, when the pickleball paddle is located in the opening, to simultaneously clean the front and back striking surfaces of the pickleball paddle.

12. The pickleball paddle cleaning apparatus according to claim 11, wherein the electronic circuit is further configured to detect a presence of the pickleball paddle in the opening, and in response to the detecting, automatically control the pressure-exertion mechanism to move at least one of the first cleaning pad and the second cleaning pad to make contact with the front striking surface and the back striking surface, respectively, of the pickleball paddle located in the opening, and wherein the electronic circuit is further configured to control the contact of the first cleaning surface and the second cleaning surface in accordance with a type of the pickleball paddle.

13. The pickleball paddle cleaning apparatus according to claim 12, wherein the electronic circuit is configured to access a paddle type table data structure in a memory and perform the controlling the contact in accordance with a content in the paddle type table data structure.

14. The pickleball paddle cleaning apparatus according to claim 12, wherein the automatically controlling the pressure-exertion mechanism to move at least one of the first cleaning pad and the second cleaning pad to make contact with the front striking surface and the back striking surface, respectively, of the pickleball paddle located in the opening comprises automatically controlling at least one of a first movement of the first and second cleaning pads towards each other and a second movement of the first and second cleaning pads parallel to each other.

15. The pickleball paddle cleaning apparatus according to claim 12, wherein the automatically controlling a mechanism to move at least one of the first cleaning pad and the second cleaning pad to make contact with the front striking surface and the back striking surface, respectively, of the pickleball paddle located in the opening comprises automatically controlling a first movement of the first and second cleaning pads towards each other and a second movement of the first and second cleaning pads parallel to each other.

16. The pickleball paddle cleaning apparatus according to claim 15, wherein the electronic circuit is further configured to control the first movement and/or the second movement in accordance with one or more parameters in a lookup table.

17. The pickleball paddle cleaning apparatus according to claim 16, wherein the one or more parameters include a pressure level and a cleaning pad movement distance.

18. The pickleball paddle cleaning apparatus according to claim 17, wherein the electronic circuit comprises at least one of a pressure sensor and a paddle presence detection sensor.

19. The pickleball paddle cleaning apparatus according to claim 15, wherein the electronic circuit further comprises a timer and wherein: the first movement and/or the second movement is controlled in accordance with the timer, or the pressure-exertion mechanism is controlled in accordance with the timer.

20. The pickleball paddle cleaning apparatus according to claim 15, further comprising at least one of:
one or more vibration generation devices configured to vibrate the paddle and/or the plates; and.
one or more suction and/or blowing devices.
